(19) United States
(12) Patent Application Publication
(10) Pub. No.: US 2026/0311280 A1
(43) Pub. Date: Oct. 8, 2026

(54) SYSTEM AND METHOD LEVERAGING GENERATIVE ARTIFICIAL INTELLIGENCE TO PREVENT FUTURE DIGITAL TRANSACTIONS USING DIGITAL AVATARS OF EXPIRED ENTITIES

(71) Applicant: Bank of America Corporation, Charlotte, NC (US)

(72) Inventors: Subburathinam Krishnan, Chennai (IN); Joseph Pyles Rose, Murphy, TX (US); Charles Patrick Kopca, Garland, TX (US); Jayaprakash Raman, Hyderabad (IN); Ajai MV, Hyderabad (IN); Sohail Lalani, Stevenson Ranch, CA (US)

(21) Appl. No.: 19/169,101

(22) Filed: Apr. 3, 2025

(51) Int. Cl. G06Q 50/18; G06Q 40/02; G06Q 40/06; G06Q 40/08

(52) U.S. Cl. CPC G06Q 50/186; G06Q 40/02; G06Q 40/06; G06Q 40/08

(57) ABSTRACT

A system and method may leverage Gen AI to prevent future digital transactions by fraudulent actors using digital avatars of an expired entity. A proof of death may be generated for an expired entity, such as a deceased person, and recorded on the blockchain. An avatar associated with the expired entity may control digital assets or rights associated with the avatar. The avatar of the expired entity may be caused to expire to prevent future use by generating an electronic proof of expiry of the avatar that is recorded in a blockchain ledger or in an avatar repository. A beneficiary of assets or rights controlled by the expired avatar may be determined. When there is no nominee, an NFT that indicates that there is no nominee may be recorded on the blockchain, and legal authorities may handle the disposition of the assets or rights of the expired avatar.

### FIELD OF THE DISCLOSURE

Aspects of the disclosure relate to permanently causing avatars of people who are deceased or other expired entities to expire and remain unused by others to prevent fraud and reduce a carbon footprint of unused avatars.

### BACKGROUND OF THE DISCLOSURE

Existing laws and regulations govern the handling of assets in a centralized environment (CT), such as in a traditional banking world, when a person passes away. An entity that becomes aware of the passing of an individual in one or more ways, such as a communication from a family member, an executor or otherwise will freeze deceased accounts upon learning that the account owner has died. The money and belongings (e.g., if stored in a bank vault) will be handed over to the legal heirs in accordance with legal requirements.

In a decentralized environment (DT), such as in a virtual world, a person may use virtual digital avatars, such as virtual 3D digital avatars, created for use in the metaverse to serve as a proxy for the person. Avatars in a DT environment may hold digital assets, perform virtual transactions, such as DT banking transactions, or perform a host of other functions including, for example interacting with other users, attending virtual events, performing scheduled transactions, making systematic investments, or exploring virtual spaces, to name a few.

Criminals may generate fake digital identities using avatars to commit fraud in the DT environment rather than using other techniques to commit fraud in a CT environment, especially because avatars are ubiquitous and photorealistic. The fraud may be in various forms, such as, for example, stealing assets associated with an avatar or entering into transactions while posing as the owner of the avatar. The potential for fraud being committed using avatars may increase upon the expiration of the avatar owner, such as when a person dies or an entity other than a person expires, if the avatars are allowed to remain valid. Fraudsters may learn of an avatar owner's death or expiration and may anticipate an opportunity that their perpetuation of a fraud using an avatar of an expired entity will go unnoticed.

It may be desirable to prevent avatars of an expired entity from being used to commit fraud.

### SUMMARY OF THE DISCLOSURE

It is an object of this invention to provide a system and method that causes avatars to expire after expiration of the avatar's owner and that records a proof of the expiration to prevent the recreation of the expired avatar.

It is a further object of this invention to provide a system and method that enables digital assets or other rights associated with the avatar to be transferred to a human nominee or an avatar nominee.

A method in accordance with the present disclosure may be implemented for preventing future digital transactions in a DT environment using a first avatar of an entity that has expired. The entity may be a person who has become deceased or may be another entity other than the deceased person. The method may include receiving, at a processor in the DT environment, a notification from a CT environment that the entity has expired. The method may include identifying, at the DT environment using generative artificial intelligence (Gen AI), the first avatar that is associated with the expired entity and is usable in a virtual environment to perform digital transactions in the DT environment. The method may include generating, in the DT environment using Gen AI, an electronic proof of expiry (POE) of the first avatar and recording the POE in a blockchain ledger to cause the first avatar to expire and become an expired avatar. The method may include identifying, by the processor using Gen AI, digital assets or rights to perform digital transactions controlled by the expired avatar. The method may include determining, by the processor using Gen AI, whether there is a nominee that has been designated to be a recipient of the digital assets or rights to perform digital transactions controlled by the expired avatar. The method may include, in response to a determination that a nominee exists, transferring, by the processor, the digital assets or the rights to perform digital transactions from the expired avatar to a second avatar controlled by the nominee.

When the entity is a person, the method may include determining, in the CT environment using Gen AI, that the person is deceased, and in response to the determination that the person is deceased, generating, in the CT environment using Gen AI, an electronic proof of death (POD) representing that the person is deceased. The method may include recording the POD on the blockchain ledger. The POE that is generated in the DT environment may be based at least in part on the POD for the deceased person.

The determination that the person is deceased may be based at least in part on one or more of online obituaries, social media, newspapers, local news websites, a message or posting of sentiments and memories from friends or family, websites of places of worship, a search engine, genealogy, updated family trees, digital archives, or government records.

The method may cause the generation of the second avatar that represents the nominee and may transfer the digital assets or rights to perform digital transactions controlled by the expired avatar to the second avatar.

The second avatar may be a pre-existing avatar of the nominee. The transfer of the digital assets may include merging the digital assets or rights to perform digital transactions controlled by the expired avatar with the pre-existing avatar of the nominee.

The nominee may be a human nominee that controls the second avatar. The nominee may be an avatar nominee.

When there is no designated nominee, the method may include transferring the digital assets to a legal representative to serve as a custodian of the digital assets, to ascertain to whom the digital assets belong.

The method may include destroying the expired avatar and recording the destruction of the expired avatar on the blockchain ledger.

The determination of the nominee may be performed using Gen AI based at least in part on one or more of a bank account, an insurance document, a land asset, an asset certificate, a record in a smart contract, or a legal document.

The digital assets may include one or more of non-fungible tokens (NFTs), cryptocurrency, photos, manuscripts, or files stored on digital storage on a user device.

The digital transactions that the first avatar is configured to perform may include one or more of performing banking transactions, interacting with other users, attending virtual events, performing scheduled transactions, making systematic investments, or exploring virtual spaces.

The first avatar used in the method may be generated in the CT environment for use in the DT environment. For example, the first avatar may be generated by a bank operating in the CT environment.

The expiration of the first avatar may reduce a carbon footprint of the expired avatar.

A method in accordance with the present disclosure may be implemented for preventing future digital transactions in a DT environment using a first avatar of an entity that has expired. The entity may be a person who has become deceased or may be another entity other than the deceased person.

The method may include receiving, at a processor in the DT environment, a notification from the CT environment that the entity has expired. The method may include identifying, at the DT environment using Gen AI, the first avatar that is associated with the expired entity and is usable in a virtual environment to perform digital transactions in the DT environment. The method may include generating, in the DT environment using Gen AI, an electronic POE of the first avatar and recording the POE in a blockchain ledger to cause the first avatar to expire and become an expired avatar. The method may include identifying, by the processor using Gen AI, digital assets or rights to perform digital transactions controlled by the expired avatar. The method may include determining, by the processor using Gen AI, whether there is a nominee that has been designated to be a recipient of the digital assets or rights to perform digital transactions controlled by the expired avatar. The method may include, in response to a determination that there is no nominee, generating, by the processor, an NFT that represents that the entity has expired and recording the NFT on the blockchain ledger.

A system in accordance with the present disclosure may be implemented for preventing an avatar associated with an expired entity from being used.

The system may include one or more Gen AI models. The one or more Gen AI models may be configured to determine that an entity is expired. The one or more Gen AI models may be configured to identify a first avatar that is associated with the expired entity and is usable in a virtual environment to own digital assets or to perform transactions in a DT environment. The one or more Gen AI models may be configured to generate, in the DT environment, a POE of the first avatar. The one or more Gen AI models may be configured to record the POE in a blockchain ledger as an indicator that the first avatar is an expired avatar that is not to be recreated. The one or more Gen AI models may be configured to identify the digital assets or rights to perform the transactions controlled by the expired avatar. The one or more Gen AI models may be configured to determine whether there is a nominee that has been designated to receive the digital assets or rights to perform the transactions controlled by the expired avatar.

The system may include a processor that is configured to record the POE in a blockchain ledger. The processor may be configured to, in response to a determination that a nominee exists, transfer control of the digital assets or rights to perform the transactions from the expired avatar to a second avatar controlled by the nominee.

The system may include a POE repository in which a copy of the POE is recorded and additional expired POEs for avatars of other expired entities may be recorded.

The system may be configured such that the determination that the entity is expired is deceased is performed in a CT environment. The one or more Gen AI models may be configured to, in the CT environment, generate a POD representing that the entity is expired, such as, for example, a person is deceased. The system may be configured to record the POD on the blockchain ledger. The system may be configured such that the POE that is generated in the DT environment is based at least in part on the POD for the expired entity that is generated.

The processor in the system may be configured to cause a generation of the second avatar that represents the nominee. The processor may be configured to transfer the digital assets or rights to perform the transactions controlled by the expired avatar to the second avatar.

The second avatar may be a pre-existing avatar of the nominee. The processor may be configured to perform the transfer of the digital assets. The transfer of the digital assets may include merging the digital assets or rights to perform the transactions controlled by the expired avatar with the pre-existing avatar of the nominee. The processor may be configured to, in response to a determination that there is no nominee, generate, by the processor, an NFT that represents that the person is deceased and record the NFT on the blockchain ledger.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system architecture in accordance with principles of the disclosure.

FIG. 2 shows an illustrative apparatus of a device in accordance with principles of the disclosure.

FIG. 3 shows an illustrative system architecture that may be used in accordance with principles of the disclosure.

FIG. 4 shows an illustrative example of a process flow diagram that may be used in accordance with principles of the disclosure.

FIG. 5 shows an illustrative flow chart for preventing the use of expired avatars from being used for future transactions in accordance with principles of the disclosure.

### DETAILED DESCRIPTION OF THE DISCLOSURE

An authentication system and method in accordance with principles of the disclosure may be provided to protect the integrity of digital avatars in a DT environment. The system and method may be used to cause an avatar to expire when it is determined that the owner of the avatar has expired. The owner may be, for example, a person that has become deceased or another entity that has expired, such as, for example, a business entity that has expired and is unable to remain in operation due to non-payment of required government fees.

Data sources may be monitored to determine whether an entity has expired. The monitoring may be performed in real-time or periodically. The monitoring may detect anomalies that may trigger a review of the entity's status. For example, an anomaly that may trigger a review may be that the entity has not used the avatar for a length of time (e.g., 90 days). This non-use may reflect that the entity is expired, e.g., the person has become deceased, so it may be desirable to verify whether this is correct.

When the expired entity is a person, there may be various channels to determine that a person is deceased. The data sources that may be monitored by a Gen AI engine, using a Gen AI model, may include, for example, one or more of online obituaries, social media, newspapers, local news websites, a message or posting of sentiments and memories from friends or family, websites of places of worship, a search engine, genealogy, updated family trees, digital archives, government records, or other sources, to name a few. The system may monitor death information included in a blockchain distributed ledger. Where the expired entity is not a person, some of the same data sources or other data sources may be monitored.

An AI model may be configured to monitor the data sources to determine whether the entity has expired, such as whether a person has died. Predictive or Gen AI models or a mix of predictive and Gen AI models may be used in one or more Gen AI engines to cross-check this information with known information about the person, such as a social security number (SSN), a last known address, or a family tree of the person to verify that a person's identity. The determination may therefore be based on one or more of the available data and based on past accuracy of the different data sources. As an additional check, before a person is declared to be deceased, a communication may be sent to the person, a relative, or other representative of the person to check whether the person is still alive. The communication may request that a reply be sent by a certain deadline. The communication may be sent by email, text, instant message, or in a different manner.

The data sources and a determination of death for an expired entity, such as deceased person, may be made in a CT environment. The CT environment may include the CT resources of a business. When the system and method determine that the entity has expired, such as a person has passed away, a POD may be automatically generated in the CT environment using Gen AI. The POD may constitute an electronic digital certification that indicates that the entity has expired, such as the person has died. The POD may be recorded on a blockchain ledger. The POD may be recorded on the blockchain ledger in the form of an NFT. The POD may be transmitted to the DT environment to inform the DT environment of the passing of the deceased. Upon receipt of the POD in the DT environment, the avatar associated with the expired entity, such as a deceased person, may be caused to expire.

A POE of the avatar may be generated in the DT environment to cause an avatar that represented an expired entity, such as the deceased, to expire, i.e., to be no longer active. The POE may be accessible to avatar generators that are configured to prevent the recreation of expired avatars in the future by anyone, including any potential fraudster. The POE may be posted to a blockchain ledger. The blockchain ledger may be the same blockchain ledger to which the PODs are recorded or may be a different blockchain ledger. The POE may be saved in an avatar repository which may be designated for recording avatars, including expired avatars. If there is a POE recorded on the blockchain ledger or stored in the avatar repository, the avatar may become expired and permanently frozen such that it is non-usable in a future digital transaction.

Gen AI may also be used to identify the one or more valid digital avatar(s) of an expired entity, such as a deceased person. This determination may be performed in the DT environment in which the digital avatars may be used.

Digital avatars have been acquired by an expired entity in different ways. For example, a bank operating in the CT environment may assign an avatar to a customer to use for transactions in the DT environment or the now-deceased person may have generated the avatar. The avatars may control assets of the deceased person which may include, for example, digital assets, such as one or more NFTs or cryptocurrencies, or other assets of the deceased person. The avatars may be authorized to schedule transactions on behalf of the person in the DT environment. The assets, scheduled transactions and other rights associated with the avatar may also be determined, for example, using the Gen AI.

Fraud may be prevented by having avatars operating in the DT environment check the blockchain ledger for a POE, an avatar repository that includes copies of the POE, or both before executing a digital transaction in the DT environment. The repository may be a repository just for expired avatars or may be a repository that includes details about active avatars and expired avatars. The POE may include a copy of the expired avatar and details related to the avatars, including some history of the avatars, such as ownership information, dates of creation and expiration of the avatar, or a reason for expiration of the expiration of the avatar.

The system may be configured such that the existence of a POE on the blockchain ledger may prevent the expired avatar from being used to perform functions of the expired avatar that may have been previously permitted, such as performing transactions, attending meetings or events, and preventing access by the expired avatar to digital assets. However, a transfer of permissions and assets to the nominee person or avatar may be permitted. Moreover, the generation of the POE may cause the deletion of the expired avatar permanently from all transactions to which it may be connected. A message may be transmitted to participants in these transactions alerting third parties or their avatars of the avatar expiration.

Gen AI may also be used to determine whether another person, entity, or avatar has been designated as a “nominee” to assume control of assets controlled by an expiring avatar(s). The “nominee” may have been nominated by the owner of the avatar before the owner (expired entity) died. The nominee may be, for example, a beneficiary of the deceased, such as a legal heir, or an authorized person to serve as a custodian under applicable laws. The nominee may be a person or another avatar controlled by a person other than the deceased. The nominee may be identified by a predictive analysis using an algorithm that analyzes, for example, one or more of various records such as bank accounts, various insurance policies owned by the deceased, employer of the deceased, or government records, such as federal government documents, related to the account holder. Gen AI may be used to predict the latest nominee when different persons are assigned as nominees in different documents. The predictive algorithm may assign whichever nominee is the latest nominee to be designated. A handshaking mechanism may be used to confirm the nominee before transferring access to the nominee per legal requirements. The confirmation may be performed relatively quickly in a short span of time to limit the opportunities for fraudsters to conduct an illegal transaction using the deceased's avatar.

Because the nominee may be changed by the owner of the avatar before the owner becomes deceased, the Gen AI may need to determine who is the current nominee from multiple identified nominees. In addition to transferring control of the assets to the nominee, other controls enabled by the expired avatar may be assigned to an avatar of the nominee. The avatar of the nominee may be an avatar specifically created by or for the nominee to receive digital assets or other controls enabled by the expired avatar. The avatar of the nominee may be an existing avatar of the nominee. In the latter case, where the nominee's avatar already controls its own digital assets, digital assets associated with the avatar of the deceased may be merged with existing assets of the nominee. There may be multiple current nominees of the deceased, such as multiple beneficiaries, in which case a single avatar of the nominee may be used to control the digital assets or the digital assets belonging to the avatar of the deceased may be split among avatars belonging to multiple nominees.

If the Gen AI determines that the deceased person did not specify a nominee, the digital assets associated with the avatar may be transferred to a legal representative, such as an executor appointed by the deceased or a representative appointed by a court, to determine to whom the digital assets are to be transferred. If there is no nominee, a copy of the avatar and related information, such as may be included in a POE, and information that there is no nominee may be saved as an NFT that is recorded on the blockchain ledger. The NFT may include a copy of the POE. This NFT may be referred to as a Dead NFT (DNFT). The NFT, like the POE, may serve as an indicator of avatar expiration to prevent the recreation of the expired avatar by another entity.

The determinations as to the avatars and the nominees may be performed in real-time or with frequency to better protect against fraud, or may be performed periodically.

The digital assets associated with the avatar(s) of the deceased may be transferred to the control of the nominee or to one or more avatars associated with the nominee for management of the assets in the metaverse DT environment. The transfer may safeguard transactions, digital assets, financial matters, and virtual matters with other users from unauthorized access. The handover of assets may include providing the nominee with access to the private keys or wallet address to access cryptocurrency wallet of the deceased person's avatar. The nominee may proceed with future virtual transactions that were scheduled to be performed in the metaverse by the expired avatars. Determinations and actions in the DT environment, including the expiration of the avatar, may be reported back to the CT environment. Existing chats conducted using the expired avatars may also be transferred to the new or pre-existing avatar of the nominee.

Expired avatars may be permanently destroyed. The digital assets controlled by the deceased's avatar may be merged with assets in the nominee's avatar. A new avatar may be created for use by the nominee to assume the responsibilities or rights of an expired avatar including, for example, management of the digital assets, including NFTs, performing transactions, or controlling the responsibilities or rights of the expired avatar, such as asset management or performing transactions. The responsibilities or rights may be transferred to an existing avatar of the nominee. The expired avatars may be permanently disabled for use. The system may be green mining-compliant by causing unused avatars to be destroyed and reducing the carbon footprint of activities associated with monitoring and maintaining records for unused avatars.

As noted above, POEs or DNFTs may also be generated as described above to cause an avatar for an expired entity, other than a deceased person, to expire such that it cannot be later recreated. The expired entity may become expired when, for example, a company stops paying government fees to stay in business and the business goes inactive. Different data sources may be relied upon to determine that the entity has expired. Where the entity had an avatar, the generation of a POE or a DNFT corresponding to the entity will cause the avatar to expire.

Illustrative embodiments of methods, systems, and apparatus in accordance with the principles of the invention will now be described with reference to the accompanying drawings, which form a part hereof. It is to be understood that other embodiments may be used, and structural, functional, and procedural modifications may be made without departing from the scope and spirit of the present invention.

The drawings show illustrative features of methods, systems, and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

The methods, apparatus, computer program products, and systems described herein are illustrative and may involve some or all the steps of the illustrative methods and/or some or all of the features of the illustrative system or apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

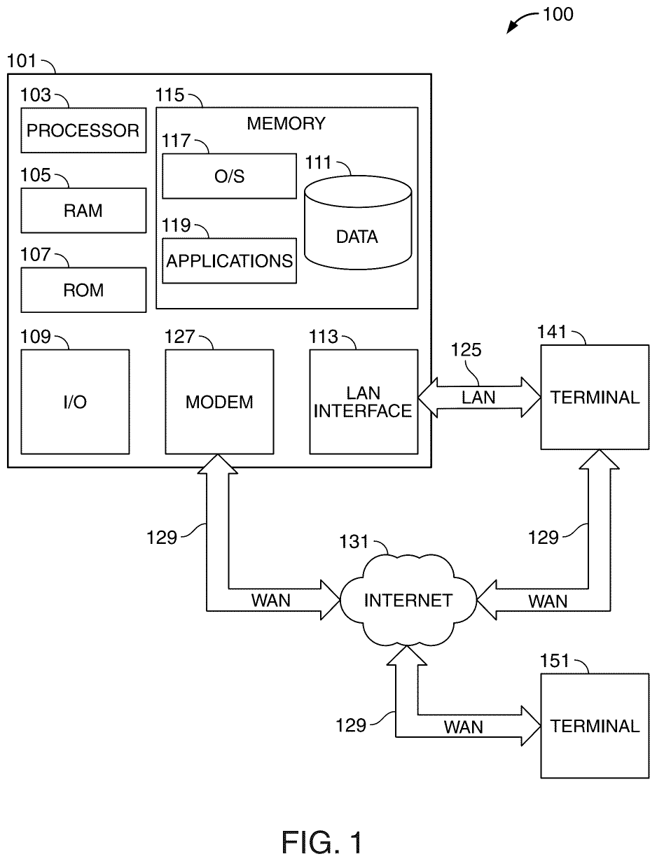

FIG. 1 shows an illustrative block diagram of system 100 that includes computer 101. Computer 101 may alternatively be referred to herein as an “engine,” “server” or a “computing device.” Computer 101 may be any computing device described herein, such as the computing devices running on a computer, smart phones, smart cars, smart cards, and any other mobile device described herein. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

Memory 115 may be comprised of any suitable permanent storage technology—e.g., a hard drive. Memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all the elements described above relative to computer 101.

In some embodiments, computer 101 and/or Terminals 141 and 151 may be any of mobile devices that may be in electronic communication with consumer device 106 via LAN, WAN, or any other suitable short-range communication when a network connection may not be established.

When used in a LAN networking environment, computer 101 is connected to LAN 125 through a LAN interface 113 or an adapter. When used in a WAN networking environment, computer 101 may include a communications device, such as modem 127 or other means, for establishing communications over WAN 129, such as Internet 131.

In some embodiments, computer 101 may be connected to one or more other systems via a short-range communication network (not shown). In these embodiments, computer 101 may communicate with one or more other terminals 141 and 151, such as the mobile devices described herein etc., using a personal area network (PAN) such as Bluetooth®, NFC (Near Field Communication), ZigBee, or any other suitable personal area network.

It will be appreciated that the network connections shown are illustrative and other means of establishing a communications link between computers may be used. The existence of various well-known protocols such as TCP/IP, Ethernet, NFT, HTTP, and the like is presumed, and the system can be operated in a client-server configuration to permit retrieval of data from a web-based server or API (Application Programming Interface). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may use one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may use the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 151 and/or terminal 141 may be portable devices such as a laptop, cell phone, Blackberry TM, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

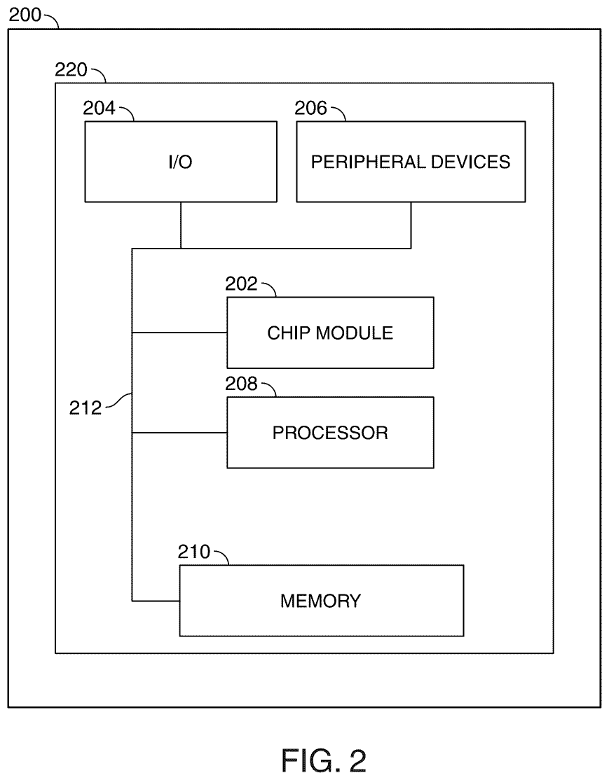

FIG. 2 shows illustrative apparatus 200, which may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY level hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

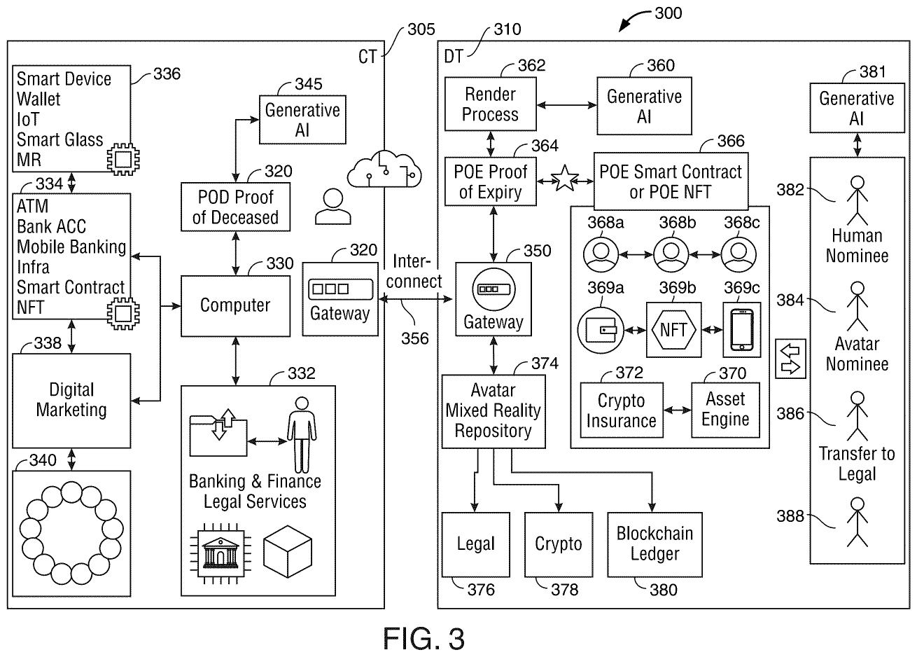

FIG. 3 shows an illustrative system architecture which may be used to provide a system 300 in accordance with principles of the disclosure. The system architecture may encompass both an illustrative CT environment 305 interconnected with an illustrative DT environment 310 via respective gateways 320, 350 that are interconnected via 356, such as over the Internet. The illustrative system architecture is shown for an expired entity that corresponds to a deceased person.

In the illustrative CT environment 305, an entity 334, such as a bank, may interact with a user device at 336. The entity may, for example, offer bank accounts, automated teller machines (ATMs), mobile banking, other infrastructure, and services such as generating avatars for customers, recording smart contracts, or generating or holding NFTs. Banks may provide digital marketing 338 and may provide various banking systems or subsystems at 340 that perform banking activities. User devices to interact with entity 334 may include one or more of a smart device, a digital wallet, an Internet of Things device 336, smart glasses, or a mixed reality (MR) device. One or more of these user devices, such as smart glasses, may be configured to use an avatar in the metaverse.

The banking and digital marketing in the CT environment may be conducted using a computer 330, such as a server, and may provide banking, finance, and legal services 332. Computer 330 may be configured to monitor, such as with Gen AI 345, whether a customer of the entity has died. If the customer is deceased, a POD may be generated at 320 and recorded on a blockchain ledger. A copy of the POD may be transmitted via gateways 320, 350 to the DT environment 310. A copy of the POD may be provided to the banking systems or subsystems 340 to update the systems with the POD information.

In response to receipt of a POD in the DT environment 310, Gen AI 360 may be used to render a POE 364 of the avatar that may be recorded in a blockchain ledger. POE 364 may include a visual rendering of the expired avatar. POE 364 may include information such as, for example, the name of the owner of the avatar who is now deceased, a copy of the avatar that is now expired, date of creation of the avatar, date of expiry of the avatar, date of death of the owner, and a record of the assets and rights that were associated with the avatar.

POE 364 may be recorded in a smart contract, as an NFT 366, or in a smart contract and as an NFT. A copy of the smart contract or NFT may be shared, such as among users 368a, 368b, or 368c who may have, for example, different devices 369a, 369b, or 369c. An asset engine 370 may record the digital assets associated with the expired avatar. Crypto insurance 372 may already be in place or may be acquired to protect the digital assets which may be maintained in asset engine 370. Asset engine 370 may be maintained by the owner of the avatar or by a third party other than the owner of the avatar.

A copy of the POE 364 may be transmitted through gateway 350. A record of POE 364 may be transmitted to an avatar mixed reality repository 474 that includes avatars. Mixed reality repository 474 may be a data repository for avatars. A record of POE 364 may be obtained from avatar mixed reality repository 374 and forwarded to a user device or a network 376 of a legal department of the entity for processing of records to transfer ownership to the deceased person's nominee. A record of POE 364 may be obtained from repository 374 and may be recorded with cryptocurrency 378, if present in the digital assets. A copy of POE 364 may be recorded in blockchain ledger 380.

Transfer of the digital assets associated with the deceased's avatar may be made to human nominee 382 or to an avatar nominee 384, which may be an avatar of a human or a different entity if there is a nominee. If there is no nominee, the digital assets may be transferred to one or more legal representatives 386, 388 to determine disposition of the digital assets.

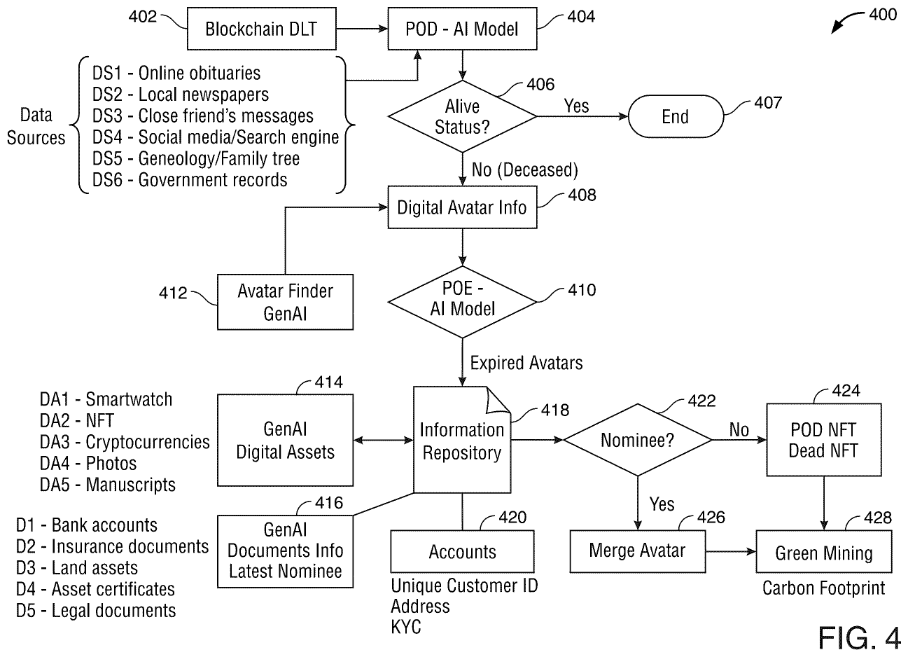

FIG. 4 shows an illustrative process flow 400 that may be implemented to leverage generative artificial intelligence to prevent future digital transactions using digital avatars of expired entities in accordance with principles of the disclosure. FIG. 4 illustrates an example in which the expired entity is a deceased person.

Process flow 400 starts at step 402, where the system may use Gen AI in the CT environment to determine whether one or more people are alive or deceased. Gen AI may be implemented using a Gen AI engine. The person of interest whose records are to be searched may be, for example, a bank customer. Gen AI may monitor and rely on a variety of data sources in reaching a determination. The monitoring may be performed in real-time. The monitoring may be performed periodically. The data sources (DS) that may be monitored by a Gen AI engine may include, for example, online obituaries, social media, newspapers, local news websites, a message or posting of sentiments and memories from friends or family, websites of places of worship, a search engine, genealogy, updated family trees, digital archives, government records, or other sources.

A determination about whether the person is alive or dead may be recorded on a blockchain ledger (DLT). At 404, an AI model may review the blockchain ledger and, if the person is deceased, may generate a POD. The POD or the alive status may be transmitted from the CT environment to the DT environment.

In the DT environment, a determination may be made at 406 as to whether the person is deceased. The determination may be reached based on information, such as a POD, received from the CT environment. If the person is determined to be alive at 406, the review of the blockchain ledger for this person's status may continue to be monitored at 404 or may end for a time at 407 before resuming monitoring for that person's alive status. However, if the person is determined to be deceased, a determination may be made at 406 as to what, if any, digital avatars 408 did the deceased have in the DT environment. For example, a bank may ascertain whether it has provided the person with an avatar. The bank may also have access to other records, such as an avatar repository, to determine other avatars of the deceased that the deceased used in the DT environment using an avatar finder 412. Avatar finder 412 may use Gen AI to identify the deceased's avatars for DT. Information for digital avatars 408 that are determined to belong to the deceased for use in the DT environment may be transmitted to POE generator 410 where a POE may be generated based on an AI model. If a POE is generated, the avatars associated with the deceased may be caused to expire at 410. Information about expired avatars, which may include copies of the avatar(s) may be transmitted to information repository 418, such as an avatar mixed reality repository.

Gen AI may be used at 414 to track for digital assets associated with the deceased avatar(s). Digital assets (DA) may be located, for example, on the deceased's smart devices, such as a smart phone or smart watch, or on another user device, such as a computer. The digital assets may include, for example, data on the smart watch, NFTs, cryptocurrencies traded in the DT environment, photos, and electronically saved manuscripts.

At 422, Gen AI may determine that there is a designated nominee for the deceased. This information may be compiled at information repository 418 based on a Gen AI search for documents and determination who the nominee is. Information repository may include the avatar mixed reality repository. If there have been more than one nominee, the latest nominee may be determined using Gen AI. There may be more than one latest nominee. Documents (D) that may be searched at 416 may include bank accounts, insurance documents, land assets, asset certificates, or legal documents. Information repository 418 may also compile accounts information 420 from a bank, such as a unique customer ID for the deceased, a customer address, and know your client (KYC) information that identifies the client, such as name, address, birthday, and social security no.

If there is a designated nominee (or nominees), at 422, the digital assets and rights associated with the expired avatar may be merged at 426 with digital assets and rights of an avatar of the nominee, such as existing avatar of the nominee, or a new avatar may be created for the nominee to hold the digital assets and rights to be transferred to the nominee. If there is no nominee, at 424 a DNFT may be created and recorded on the blockchain ledger. The DNFT may include a copy of the POD NFT that may be received from the CT environment. The record of the expired avatar may be permanently destroyed to prevent fraud so that the avatar is unusable by anyone else. The destruction of the expired avatar may also result in green mining at 428 in which that avatar is no longer used so that records and searches for that avatar are not performed. Besides preventing fraud, the destruction of expired avatars may reduce the carbon footprint caused by unused avatars.

Using the system and method in accordance with principles of the disclosure, if an entity attempts to communicate with an expired avatar, there may be no reply sent or an automated message may be sent in reply. A reply may indicate, for example, that the avatar is no longer active or that the owner is deceased. If an entity attempts to fraudulently conduct a transaction using an expired avatar, the existence of the POE may be discovered and may prevent a recreation of the same avatar.

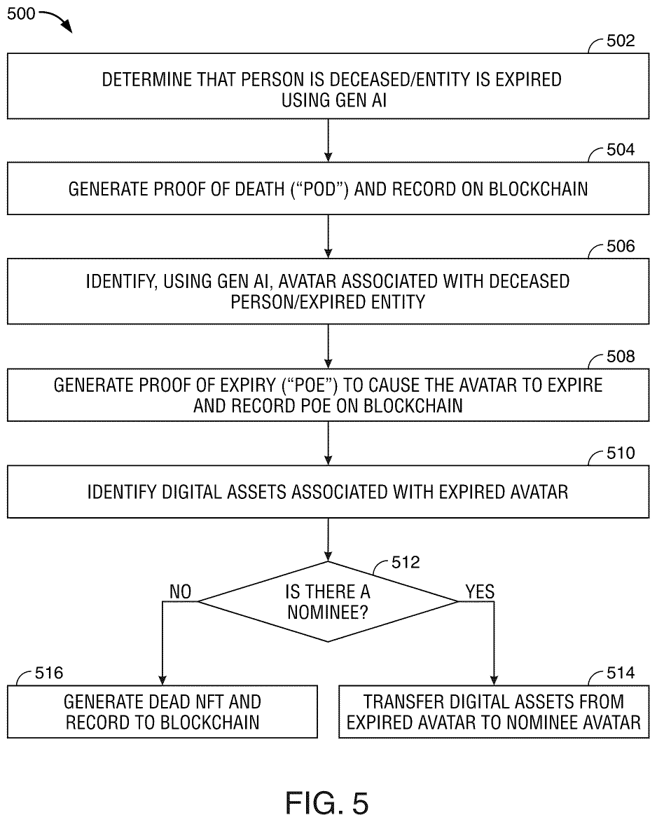

FIG. 5 shows an illustrative flow chart 500 for preventing the use of expired avatars from being used for future transactions in accordance with principles of the disclosure.

At step 502, a determination may be made that a person has died. The determination may be made using Gen AI. The determination may be made with reference to a host of different data sources. An accuracy determination may be made based on a trained AI model that may base a positive confirmation of the death on confirmation from multiple sources. At step 504, a proof of death may be generated and recorded on a blockchain ledger. The determination may be made and the POD may be generated in the CT environment. The determination may be transmitted to a DT environment, such as by transmitting a copy of the POD to the DT environment, where the POD may be received.

At step 506, Gen AI may be used to identify one or more avatars associated with the person who has been determined to be deceased. At step 508, a proof of expiry of the avatar may be generated to cause the avatar to expire. The proof of expiry of the avatar may be recorded on the blockchain ledger. At step 510, one or more of digital assets or rights to perform digital transactions or other actions that are controlled by the avatar may be determined. The order in which steps 508 and 510 may be reversed.

At step 512, Gen AI may be used to determine whether there is a nominee that has been previously appointed by the person prior to the deceased's passing that is to assume control of the assets. For example, the nominee may be a beneficiary that has been appointed in a will or some other legal document. There may have been different nominees appointed at different times so Gen AI may determine which nominee is the latest nominee. The nominee may be, for example, a person, an avatar, or a legal representative of the deceased.

If there is a nominee, at step 514, the digital assets or rights controlled by the avatar of the deceased may be transferred to the nominee. The transfer to the nominee may be a transfer to the nominee's avatar. The nominee may be an avatar. Where the transfer is to the nominee's avatar, the avatar nominee's avatar may be a newly-generated avatar to assume control of the assets or rights being transferred or the nominee's avatar may be an existing avatar of the nominee which may already control other assets or rights.

If there is no nominee that is identified by the Gen AI, at step 516, a DNFT may be generated to indicate there is no nominee associated with the avatar. The assets may be transferred to a governmental authority for disposition of the assets or rights associated with the avatar. Results for whether there is a nominee and a disposition of assets and rights controlled by the expired avatar may be reported back to the CT environment for tracking the disposition of assets and rights.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for leveraging generative artificial intelligence to prevent future digital transactions using digital avatars of expired entities may be provided. Persons skilled in the art will appreciate that the present invention can be practiced by other than the described embodiments, which are presented for purposes of illustration rather than of limitation.

What is claimed is:

1. A method of preventing future digital transactions in a decentralized environment (DT) using a first avatar of an entity that has expired, wherein the entity is a person who has become deceased or is another entity other than the deceased person, the method comprising:
receiving, at a processor in the DT environment, a notification from a centralized environment (CT) that the entity has expired;
identifying, at the DT environment using generative artificial intelligence (Gen AI), the first avatar that is associated with the expired entity and is usable in a virtual environment to perform digital transactions in the DT environment;
generating, in the DT environment using Gen AI, an electronic proof of expiry (POE) of the first avatar and recording the POE in a blockchain ledger to cause the first avatar to expire and become an expired avatar;
identifying, by the processor using Gen AI, digital assets or rights to perform digital transactions controlled by the expired avatar;
determining, by the processor using Gen AI, whether there is a nominee that has been designated to be a recipient of the digital assets or rights to perform digital transactions controlled by the expired avatar; and
in response to a determination that a nominee exists, transferring, by the processor, the digital assets or the rights to perform digital transactions from the expired avatar to a second avatar controlled by the nominee.

2. The method of claim 1, wherein the entity is the person who has become deceased, further comprising:
determining, in the CT environment using Gen AI, that the person is deceased,
in response to the determination that the person is deceased, generating, in the CT environment using Gen AI, an electronic proof of death (POD) representing that the person is deceased; and
recording the POD on the blockchain ledger;
wherein the POE that is generated in the DT environment is based at least in part on the POD for the deceased person.

3. The method of claim 2, wherein the determination that the person is deceased is based at least in part on one or more of online obituaries, social media, newspapers, local news websites, a message or posting of sentiments and memories from friends or family, websites of places of worship, a search engine, genealogy, updated family trees, digital archives, or government records.

4. The method of claim 1, further comprising causing a generation of the second avatar that represents the nominee and transferring the digital assets or rights to perform digital transactions controlled by the expired avatar to the second avatar.

5. The method of claim 1, wherein:
the second avatar is a pre-existing avatar of the nominee; and
the transfer of the digital assets comprises merging the digital assets or rights to perform digital transactions controlled by the expired avatar with the pre-existing avatar of the nominee.

6. The method of claim 1, wherein the nominee is a human nominee that controls the second avatar.

7. The method of claim 1, wherein the nominee is an avatar nominee.

8. The method of claim 1, further comprising, when there is no designated nominee, transferring the digital assets to a legal representative to serve as a custodian of the digital assets, to ascertain to whom the digital assets belong.

9. The method of claim 1, further comprising destroying the expired avatar and recording the destruction of the expired avatar on the blockchain ledger.

10. The method of claim 1, wherein the determination of the nominee is performed using Gen AI based at least in part on one or more of a bank account, an insurance document, a land asset, an asset certificate, a record in a smart contract, or a legal document.

11. The method of claim 1, wherein the digital assets comprise one or more of non-fungible tokens, cryptocurrency, photos, manuscripts, or files stored on digital storage on a user device.

12. The method of claim 1, wherein the digital transactions that the first avatar is configured to perform include one or more of performing banking transactions, interacting with other users, attending virtual events, performing scheduled transactions, making systematic investments, or exploring virtual spaces.

13. The method of claim 1, wherein the entity operating in the CT environment generates the first avatar for use in the DT environment.

14. The method of claim 1, wherein the expiration of the first avatar reduces a carbon footprint of the expired avatar.

15. A method of preventing future digital transactions in a decentralized environment (DT) using a first avatar of an entity that has expired, wherein the entity is a person who has become deceased or is another entity other than the deceased person, the method comprising:
receiving, at a processor in the DT environment, a notification from the centralized (CT) environment that the entity has expired;
identifying, at the DT environment using generative artificial intelligence (Gen AI), the first avatar that is associated with the expired entity and is usable in a virtual environment to perform digital transactions in the DT environment;
generating, in the DT environment using Gen AI, an electronic proof of expiry (POE) of the first avatar and recording the POE in a blockchain ledger to cause the first avatar to expire and become an expired avatar;
identifying, by the processor using Gen AI, digital assets or rights to perform digital transactions controlled by the expired avatar;
determining, by the processor using Gen AI, whether there is a nominee that has been designated to be a recipient of the digital assets or rights to perform digital transactions controlled by the expired avatar; and
in response to a determination that there is no nominee, generating, by the processor, a non-fungible token (NFT) that represents that the entity has expired and recording the NFT on the blockchain ledger.

16. A system for preventing an avatar associated with an expired entity from being used, the system comprising:
one or more generative artificial intelligence (Gen AI) models that are configured to:
determine that an entity is expired;
identify a first avatar that is associated with the expired entity and is usable in a virtual environment to own digital assets or to perform transactions in a decentralized environment (DT);
generate, in the DT environment, an electronic proof of expiry (POE) of the first avatar and recording the POE in a blockchain ledger as an indicator that the first avatar is an expired avatar that is not to be recreated;
identify the digital assets or rights to perform the transactions controlled by the expired avatar; and
determine whether there is a nominee that has been designated to receive the digital assets or rights to perform the transactions controlled by the expired avatar;
a processor that is configured to:
record the POE in a blockchain ledger; and
in response to a determination that a nominee exists, transfer control of the digital assets or rights to perform the transactions from the expired avatar to a second avatar controlled by the nominee; and
a POE repository in which a copy of the POE is recorded and additional expired POEs for avatars of other expired entities are recorded.

17. The system of claim 16, wherein:
the system is further configured to perform the determination that the entity is expired in a centralized environment (CT); and
the one or more Gen AI models are further configured to, in the CT environment:
generate an electronic proof of death certificate (POD) representing that the entity is expired; and
record the POD on the blockchain ledger;
wherein the POE is generated in the DT environment based at least in part on the POD for the expired entity that is generated.

18. The system of claim 16, wherein the processor is further configured to cause a generation of the second avatar that represents the nominee, and to transfer the digital assets or rights to perform the transactions controlled by the expired avatar to the second avatar.

19. The system of claim 16, wherein:
the second avatar is a pre-existing avatar of the nominee; and
the processor is further configured to perform the transfer of the digital assets comprising merging the digital assets or rights to perform the transactions controlled by the expired avatar with the pre-existing avatar of the nominee.

20. The system of claim 16, wherein the processor is further configured to:
in response to a determination that there is no nominee, generate, by the processor, a non-fungible token (NFT) that represents that the person is deceased and record the NFT on the blockchain ledger.
